(19) United States
(12) Patent Application Publication
(10) Pub. No.: US 2008/0185136 A1
(43) Pub. Date: Aug. 7, 2008

(54) Heat exchanger with bypass seal

(76) Inventors: Gerard W. Vastine, Lake Villa, IL (US); David E. Janke, Racine, WI (US); Darron Peddle, Millersburg, IN (US)

Correspondence Address: MICHAEL BEST & FRIEDRICH LLP, 100 E WISCONSIN AVENUE, Suite 3300, MILWAUKEE, WI, 53202, US

(21) Appl. No.: 11/703,501

(22) Filed: Feb. 7, 2007

(51) Int. Cl. G05D 16/00

(52) U.S. Cl. 165/283

(57) ABSTRACT

A heat exchanger (24) is provided and includes a heat exchanger core (30), a housing (32), and a seal structure (34). The core (30) has a pair of opposite faces bounded by a periphery (40), and includes a plurality of enclosed flow passages (50) to direct a first fluid through the core (30) and a plurality of open flow passages (52) extending between their opposite faces (36, 38) to direct a second fluid through the core (30). The seal structure (34) is sandwiched between the housing (32) and a majority of the periphery (40) to restrict bypassing of the second fluid around the open flow passages (52).

### CROSS-REFERENCE TO RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### FIELD OF THE INVENTION

This invention is related to heat exchangers and in more particular applications, to intercoolers used to transfer heat from a charge air flow to a coolant between stages of a charge air compressor.

### BACKGROUND OF THE INVENTION

Heat exchangers that utilize enclosed flow passages that are interleaved with open flow passages to transfer heat between a fluid flowing through the enclosed passages and another fluid flowing through the open flow passages are known. Common examples of such heat exchangers are automotive radiators and condensers which include enclosed passages for a coolant or refrigerant interleaved with open passages for a cooling air flow. Due to a continuing desire to increase the performance of vehicular engines, whether it be for automotive, truck, or off-highway/construction-type vehicles, it has become increasingly desirable to incorporate charge air compressors that provide a pressurized air flow to the inlet of the vehicle's combustion engine. It is also desirable in such charge air systems to provide an intercooler heat exchanger that cools the pressurized charge air flow between stages of the air compressor. In view of this, there is a continuing desire to improve both the efficiency and economic production of such intercoolers.

### SUMMARY OF THE INVENTION

In accordance with one feature of the invention, a heat exchanger includes a heat exchanger core, a housing, and a seal structure.

As one feature, the seal structure is a multi-piece structure.

In one feature, the seal structure is a one-piece seal structure.

According to one feature, the core has a pair of opposite faces bounded by a four sided periphery. The core includes a plurality of enclosed flow passages extending between two opposite sides of the periphery to direct a first fluid through the core, and a plurality of open flow passages extending between the opposite faces to direct a second fluid through the core, with each of the two opposite sides of the periphery having a contoured shape defined at least partially by the enclosed flow passages. The housing surrounds the core to define an inlet manifold for the second fluid to direct the second fluid into the second flow passages at one of the faces and an outlet manifold for the second fluid to collect the second fluid from the second flow passages at the other face.

In one feature, the seal structure includes first and second seal extensions. The first extension is sandwiched between one of the two opposite sides of the periphery and a first wall of the housing to restrict bypassing of the second fluid around the second flow passages, the first extension conforming to the contoured shape of the one of the two opposite sides of the periphery. The second extension is sandwiched between a second wall of the housing and a third side of the periphery that connects the two opposite sides of the periphery.

As one feature, the seal structure further includes a third seal extension sandwiched between the other of the two opposite sides of the periphery and a third wall of the housing to restrict bypassing of the second fluid around the second flow passages, with the third extension conforming to the contoured shape of the other of the two opposite sides of the periphery. The second extension extends between and connects the first and third extensions so that the seal structure surrounds three of the sides of the periphery of the core.

In one feature, the housing includes a cast housing having a core chamber that receives the core and surrounds the core except for a fourth side of the periphery opposite from the third side. The core chamber has an inlet for the second fluid and an outlet for the second fluid and the core is positioned in the core chamber between the inlet and the outlet for the second fluid.

In accordance with one feature, the core further includes a fluid connection extending from the third side of the periphery of the core to direct the first fluid to or from the core, the second wall includes an opening sized to allow passage of the fluid connection, and the third extension includes a gasket section that engages around the fluid connection and the opening to restrict leakage of the second fluid from the housing.

According to one feature, the contoured shape of the one of the two opposite sides includes a plurality of recesses and the first extension includes a plurality of corresponding projections extending into the recesses.

In one feature, the core includes a plurality of plate pairs, with each plate pair defining one of the enclosed flow passages, and each of the open flow passage being defined between two adjacent plate pairs. The first extension includes a plurality of projections, with each of the projections extending between two adjacent plate pairs at the one of the opposite sides.

In accordance with one feature of the invention, the seal structure includes first, second and third seal extensions, with the first extension sandwiched between one of the two opposite sides of the periphery and the housing to restrict bypassing of the second fluid around the second flow passages, the second extension sandwiched between the housing and a third side of the periphery that connects the two opposite sides of the periphery, and the third extension sandwiched between the other of the two opposite sides of the periphery and the housing to restrict bypassing of the second fluid around the second flow passages.

As one feature, the first and third extensions conform to the contoured shapes of the two opposite sides of the periphery.

In one feature, the core further includes a fluid connection extending from the third side of the periphery of the core to direct the first fluid to or from the core, the housing includes an opening sized to allow passage of the fluid connection, and the third extension includes a gasket section that engages around the fluid connection and the opening to restrict leakage of the second fluid from the housing.

According to one feature, the contoured shapes of the two opposite sides includes a plurality of recesses and the first and third extensions each includes a plurality of corresponding projections extending into the recesses of the corresponding opposite side.

As one feature, the core includes a plurality of plate pairs, each plate pair defining one of the enclosed flow passages, and each of the open flow passage being defined between two adjacent plate pairs. Each of the first and third extensions includes a plurality of projections, with each of the projections extending between two adjacent plate pairs at the corresponding the opposite side.

In accordance with one feature of the invention, a heat exchanger includes a heat exchanger core, a housing, and a seal structure. The heat exchanger core has a pair of opposite faces bounded by a periphery. The core including a plurality of enclosed flow passages to direct a first fluid through the core and a plurality of open flow passages extending between the opposite faces to direct a second fluid through the core. The housing surrounds the core to define an inlet manifold area for the second fluid to direct the second fluid into the second flow passages at one of the faces and an outlet manifold for the second fluid to collect the second fluid from the second flow passages at the other face. The one-piece seal structure is sandwiched between the housing and a majority of the periphery to restrict bypassing of the second fluid around the second flow passages.

As one feature, the seal structure is a multi-piece structure.

In one feature, the seal structure is a one-piece seal structure.

As one feature, the seal conforms to contoured shapes of two opposite sides of the periphery.

In one feature, the housing includes a cast housing having a core chamber that receives the core, with the core positioned in the core chamber between an inlet and outlet for the second fluid.

In a further feature, the core further includes a fluid connection extending from the third side of the periphery of the core to direct the first fluid to or from the core, the chamber includes an opening sized to allow passage of the fluid connection, and the third extension includes a gasket section that engages around the fluid connection and the opening to restrict leakage of the second fluid from the housing.

According to one feature, two opposite sides of the periphery include a plurality of recesses, and the seal includes a plurality of corresponding projections extending into the recesses.

In one feature, the core includes a plurality of plate pairs, with each plate pair defining one of the enclosed flow passages, and each of the open flow passage being defined between two adjacent plate pairs. The seal includes a plurality of projections, with each of the projections extending between two adjacent plate pairs at the periphery of the core.

Other features, objects, and advantages of the invention will be realized by a detailed review of the entire specification, including the appended claims and drawings.

### BRIEF DESCRIPTION OF THE DRAWINGS

FIG. 1 is a diagrammatic representation of an engine system including a charge air system having an intercooler heat exchanger embodying the present invention;

FIG. 2 is a perspective view of an intercooler heat exchanger embodying the present invention;

FIG. 3 is a perspective view of a housing of the intercooler heat exchanger of FIG. 2;

FIG. 4 is a slightly enlarged perspective view of a heat exchanger core of the intercooler of FIG. 2;

FIG. 5 is an enlarged section view taken from line 5-5 in FIG. 2 with the heat exchanger core shown in phantom;

FIG. 6 is a partial section view taken from line 6-6 in FIG. 2 and rotated 180°;

FIG. 7 is an elevational view of a bypass seal utilized in the intercooler heat exchanger of FIGS. 2-5;

FIG. 8 is a view taken from line 8-8 in FIG. 7;

FIG. 9 is a view taken from line 9-9 in FIG. 7;

FIG. 10 is an enlarged broken view taken from the encircled area A in FIG. 7; and

FIG. 11 is an elevation view of an alternate embodiment of seal utilized in the intercooler heat exchanger of FIGS. 1-6; and

FIGS. 12 and 13 are views similar to FIG. 9, but showing alternate embodiments wherein the bypass seal is a multi-piece structure.

### DETAILED DESCRIPTION OF THE PREFERRED EMBODIMENTS

With reference to FIG. 1, an engine system 10 for a vehicle, such as an automobile or off-highway vehicle or truck, includes a combustion engine 12 and a charge air system 14 for providing a pressurized charge air flow 16 to the engine 12. The charge air system 14 includes a compressor 18 having first and second stages 20 and 22, and an intercooler heat exchanger 24 for cooling the charge air flow 16 between the stages 20 and 22 by transferring heat from the charge air flow to a coolant flow 26 provided by the vehicle or engine system 10. It should be understood that while the invention is described herein is the context of an intercooler heat exchanger 24, the invention may find use in other types of heat exchangers. Accordingly, no limitation to a particular type of heat exchanger or system is intended unless expressly recited in the claims.

With reference to FIGS. 2-5, the intercooler heat exchanger 24 includes a heat exchanger core 30 to direct the coolant flow 26 and the pressurized air flow 16 in heat exchange relation to transfer heat from the charge air flow 16 to the coolant flow 26, a housing 32 surrounding the core 30, and a one-piece seal structure 34 (best seen in FIG. 5) that is sandwiched between the core and the housing 32 to limit or restrict the amount of charge air flow 16 that will bypass the core 30.

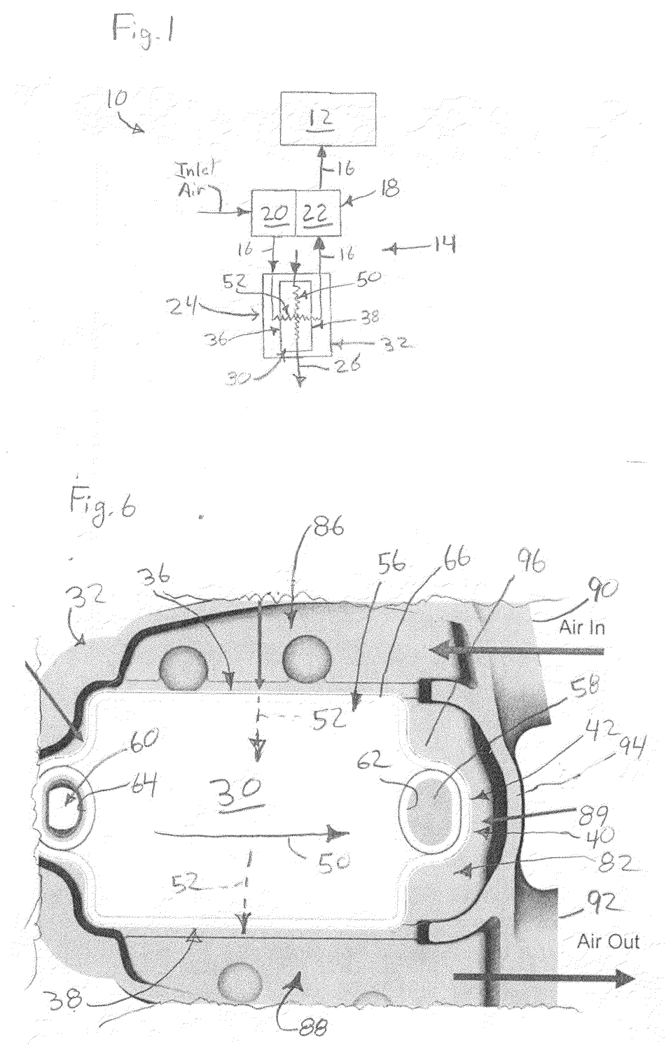

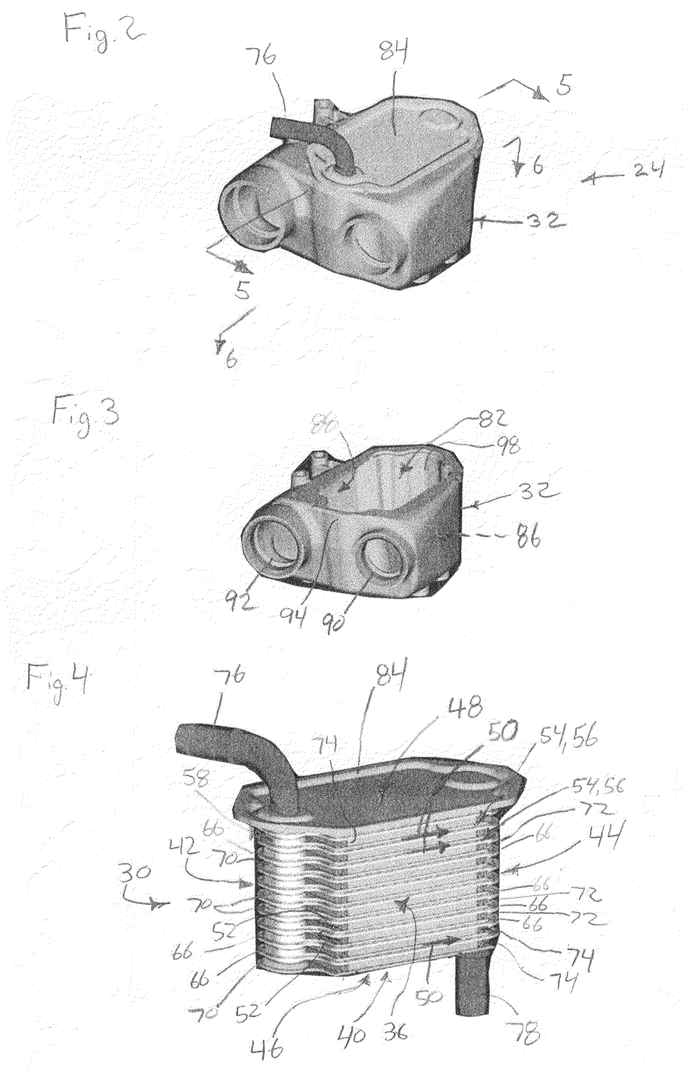

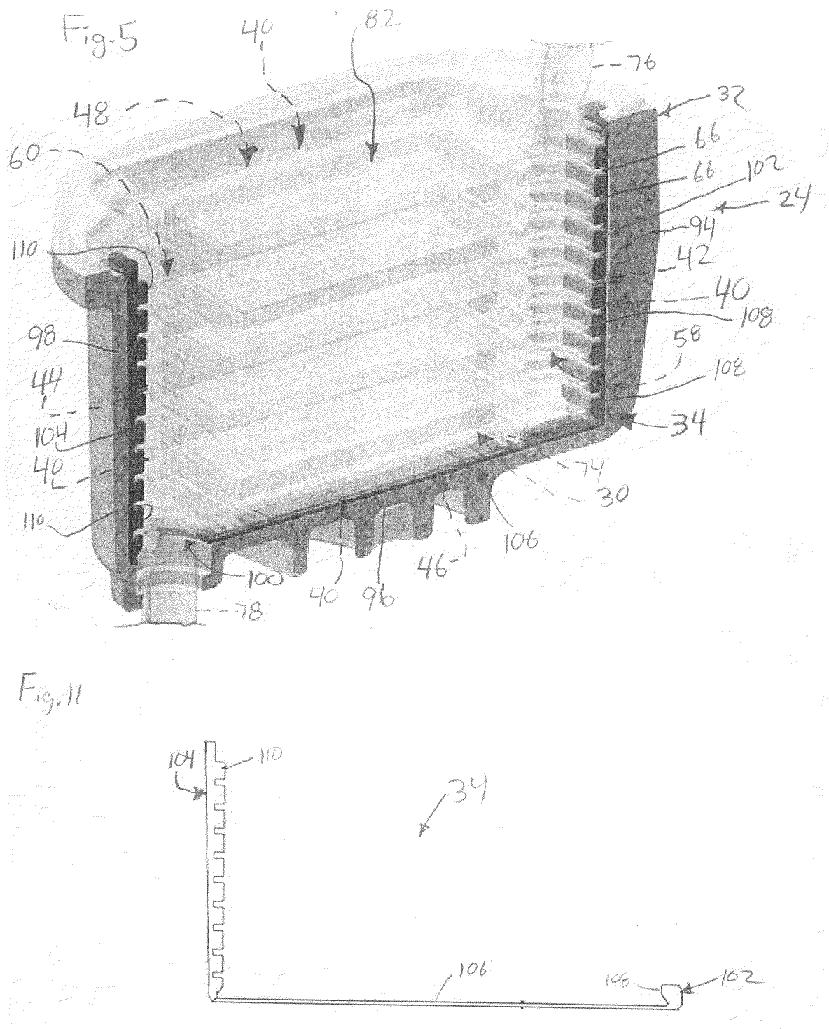

With reference to FIGS. 4-6, the core 30 has a pair of opposite faces 36 and 38 that are bounded by a periphery 40 having four sides 42, 44, 46 and 48. The core includes a plurality of enclosed flow passages, shown schematically by arrows 50, extending between the opposite sides 42 and 44 to direct the coolant 26 through the core 30, and a plurality of open flow passages, shown schematically by arrows 52, extending between the opposite faces 36, 38 to direct the charge air flow 16 through the core 30. In the illustrated embodiment, the core 30 is a brazed, stacked-plate type construction, with each of the enclosed flow passages 50 being defined by a pair 54 of embossed plates 56, and each of the open flow passages 52 being defined between two adjacent pairs 54 of the plates 56. As best seen in FIG. 6, manifolds 58 and 60 for the coolant 26 are defined by aligned, embossed openings 62 and 64, respectively, in each of the plates 56, that are brazed around their peripheries to prevent leakage of the coolant 26, as is known in such stacked plate heat exchanger core constructions. The plates 56 of each pair 54 include edge flanges 66 that are bonded to each other, such as by brazing, to enclose the passages 50, with the flanges 66 defining a contoured shape having a plurality or recesses 70 and 72 at each of the respective sides 42 and 44. Preferably, a suitable fin, such as a serpentine fin 74 (central portions not shown in FIGS. 5 and 6 for purposes of illustration), is provided in each of the open flow passages 52 between the manifolds 58 and 60 to enhance the transfer of heat from the charge air 16 to coolant 26. The core 30 preferably includes a pair of fluid connections 76 and 78 to direct the coolant flow to or from the respective manifolds 58 and 60.

While the core 30 has been described in some detail for the illustrated embodiment, it should be understood that other suitable forms of heat exchanger cores may be employed in the heat exchanger 24, including, for example, bar-plate type constructions, nested plate type constructions, and even so-called parallel flow constructions that utilize flattened or round tubes extending between a pair of header/manifold tanks.

As best seen in FIGS. 3, 5 and 6, the housing 32 is preferably a one-piece molding or casting 80 of a suitable material, such as aluminum or a suitable plastic. The housing 32 includes a core chamber 82 that receives and surrounds the core 30 except for the side 48 of the core 30, which in the preferred embodiment includes a cover 84 that encloses the core chamber 82 when the core 30 is received therein. As best seen in FIG. 6, the housing 32 defines an inlet manifold 86 to direct the charge air flow 16 into the second flow passages 52 at the face 36, and a charge air outlet manifold 88 to collect the charge air 16 from the flow passages 52 at the other face 38. It should be noted that the seal structure 34 is not shown in FIG. 6 so as to illustrate the potential for a bypass flow area, such as at 89, between the periphery 40 of the core 30 and the housing 32. The housing 32 also includes an air inlet port 90 to direct the charge air 16 into the inlet manifold 86, and an air outlet port 92 to direct the charge air 16 from the outlet manifold 88. As best seen in FIG. 5, the chamber 82 includes walls 94, 96 and 98 that surround the sides 42, 44 and 46, respectively, of the core 30. As also best seen in FIG. 5, the chamber 82 includes an opening 100 in the bottom wall 96 that is located and sized to allow passage of the fluid connection 78 of the core 30 to the exterior of the housing 32.

As best seen in FIGS. 5 and 7-10, the seal structure 34 is a one-piece construction that includes three connected seal extensions 102, 104 and 106, with the extension 102 sandwiched between the core side 42 and the wall 94 of the housing 32, the extension 104 sandwiched between the core side 46 and the wall 98 of the housing 32, and the extension 106 sandwiched between the core side 44 and the wall 96 of the housing 32. Preferably, the seal structure 34 is molded as one-piece from silicone or other suitably resilient material that allows the seal extensions 102 and 104 to conform to the contoured shape of the sides 42 and 44. In this regard, it is highly preferred that each of the extensions 102 and 104 include a plurality of finger-like projections or protrusions 108 and 110 that extend into the recesses 70 and 72, respectively, that are defined between the plate pairs 54 at each of the sides 42 and 44 of the periphery 40 of the core 30. It should be noted that, as seen in FIG. 7, the extension 104 is tapered such that it increases in the dimension D as it extends away from the extension 106. While not required, this feature is preferred when the core chamber 82 has a draft angle as may be required for the manufacture of a cast housing. As best seen in FIG. 9, extension 106 includes a gasket section 112 that engages around the fluid connection 78 and the opening 100 to restrict leakage of the charge air from the housing 32. Optionally, the extension 106 may also include a raised bead 116 that can resiliently engage the side 46 of the core 30.

During the assembly of the intercooler 24, it is desirable that the seal structure 34 be engaged around the periphery 40 of the core 30 prior to the core 30 and the seal structure 34 being inserted into the core chamber 82 of the housing 32. In this regard, it may be desirable to size the projections 108 and 110 so that they snuggly engage between the flanges 66 of adjacent plate pairs 54, and/or to provide small engaging tabs 120 on selected ones of the projections 108 and 110, as best seen in FIGS. 7, 8 and 10 that will provide an interference fit with the flanges 66 of adjacent plate pairs 54 while not requiring an overly large force to engage the tabs 120 or projections 108 and 110 into the recesses 70 and 72.

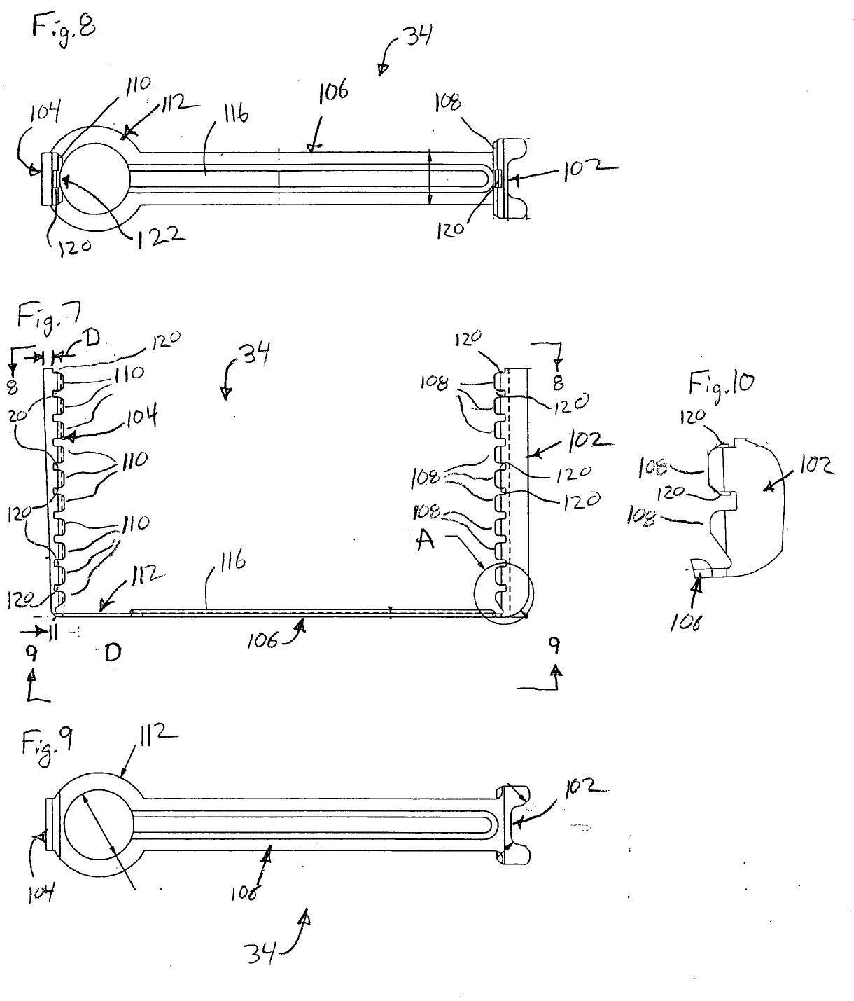

As best seen in FIG. 8, depending on the particular configuration of the core 30, it may be desirable to provide a relief, such as at 122, to provide clearance for certain features of the core, such as for the manifold 60.

With reference to FIG. 11, another option is shown for the seal structure 34 wherein the extension 102 has been significantly shortened such that there is only a single one of the projections 108, which allows for the seal structure 34 to be engaged with the core 30 during assembly of the core 30 and seal structure 34 into the housing 32. Such a construction may be desirable in intercoolers 24 wherein there is only a limited amount of potential bypass of the charge air around the corresponding side 44 of the periphery 40 as dictated by the geometry and clearances of the housing 32 and core 30.

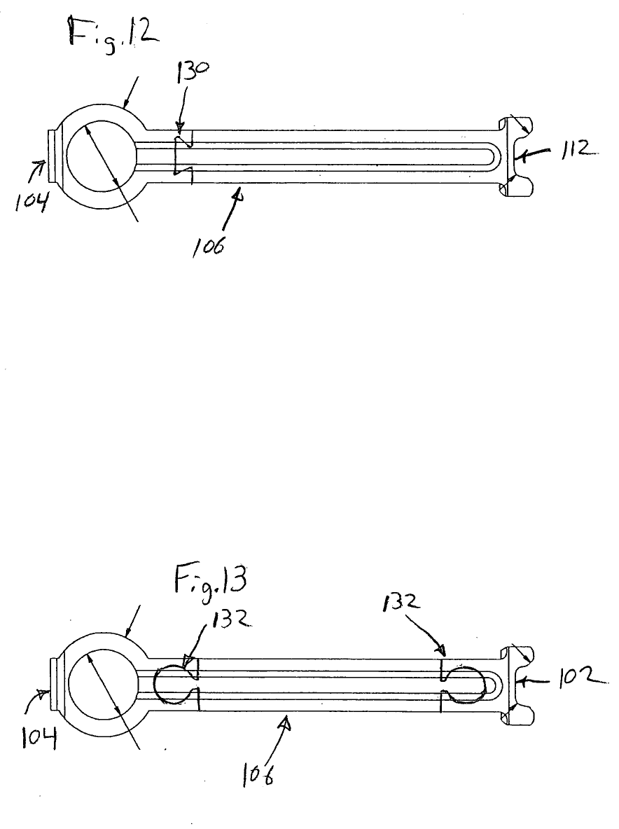

While a one-piece structure is preferred for the seal structure 34, it is also possible to form the seal structure 34 as a multi-piece structure using some suitable form of interconnecting or interlocking joint, examples of which are shown in FIGS. 12 and 13, such as an interlocking dovetail joint 130 in FIG. 12, or an interlocking tab/receiving opening, such as tabs/openings 132 in FIG. 13, to connect the individual pieces of the seal structure 34. In this regard, the location and number of such joints for each seal structure 34 will be highly dependent upon the particular parameters and geometric requirements for the seal structure 34. The joints should be sufficient to maintain a connection between all of the pieces of the seal structure 34 so that it can be installed as an integrated piece during assembly.

It should be appreciated that the purpose of the seal structure 34 is to restrict or limit (rather than completely eliminate) the leakage of charge air 16 between the housing and contoured shape of the edges 42 and 44 of the periphery 40 of the core 30. Accordingly, an absolute/air-tight seal is not required.

It should be appreciated that the seal structure 34 allows for the use of a one-piece cast housing 32 and a heat exchanger core 30, such as a brazed stack plate core, to be utilized for a heat exchanger without requiring overly tight and/or expensive tolerances or core constructions so as to limit the bypassing of air flow around the open passages 52 of the core 30.

1. A heat exchanger comprising:
a heat exchanger core having a pair of opposite faces bounded by a four sided periphery, the core comprising a plurality of enclosed flow passages extending between two opposite sides of the periphery to direct a first fluid through the core, and a plurality of open flow passages extending between the opposite faces to direct a second fluid through the core, each of the two opposite sides of the periphery having a contoured shape defined at least partially by the enclosed flow passages;
a housing surrounding the core to define an inlet manifold for the second fluid to direct the second fluid into the second flow passages at one of the faces and an outlet manifold for the second fluid to collect the second fluid from the second flow passages at the other face; and
a seal structure including first and second seal extensions, the first extension sandwiched between one of the two opposite sides of the periphery and a first wall of the housing to restrict bypassing of the second fluid around the open flow passages, the first extension conforming to the contoured shape of the one of the two opposite sides of the periphery, the second extension sandwiched between a second wall of the housing and a third side of the periphery that connects the two opposite sides of the periphery.

2. The heat exchanger of claim 1 wherein the seal structure is a multi-piece structure.

3. The heat exchanger of claim 1 wherein the seal structure is a one-piece seal structure.

4. The heat exchanger of claim 1 wherein the seal structure further comprises a third seal extension sandwiched between the other of the two opposite sides of the periphery and a third wall of the housing to restrict bypassing of the second fluid around the open flow passages, the third extension conforming to the contoured shape of the other of the two opposite sides of the periphery, the second extension extending between and connecting the first and third extensions so that the seal structure surrounds three of the sides of the periphery of the core.

5. The heat exchanger of claim 1 wherein the housing comprises a cast housing having a core chamber that receives the core and surrounds the core except for a fourth side of the periphery opposite from the third side, the core chamber having an inlet for the second fluid and a outlet for the second fluid with the core positioned in the core chamber between the inlet and the outlet for the second fluid.

6. The heat exchanger of claim 1 wherein the core further comprises a fluid connection extending from the third side of the periphery of the core to direct the first fluid to or from the core, the second wall includes an opening sized to allow passage of the fluid connection, and the third extension includes a gasket section that engages around the fluid connection and the opening to restrict leakage of the second fluid from the housing.

7. The heat exchanger of claim 1 wherein the contoured shape of the one of the two opposite sides comprises a plurality of recesses and the first extension comprises a plurality of corresponding projections extending into the recesses.

8. The heat exchanger of claim 1 wherein the core comprises a plurality of plate pairs, each plate pair defining one of the enclosed flow passages, each of the open flow passage is defined between two adjacent plate pairs, and the first extension comprises a plurality of projections, each of the projections extending between two adjacent plate pairs at the one of the opposite sides.

9. A heat exchanger comprising:
a heat exchanger core having a pair of opposite faces bounded by a four sided periphery, the core comprising a plurality of enclosed flow passages extending between two opposite sides of the periphery to direct a first fluid through the core, and a plurality of open flow passages extending between the opposite faces to direct a second fluid through the core, each of the two opposite sides of the periphery having a contoured shape defined at least partially by the enclosed flow passages;
a housing surrounding the core to define an inlet manifold for the second fluid to direct the second fluid into the second flow passages at one of the faces and an outlet manifold for the second fluid to collect the second fluid from the second flow passages at the other face; and
a seal structure including first, second and third seal extensions, the first extension sandwiched between one of the two opposite sides of the periphery and the housing to restrict bypassing of the second fluid around the open flow passages, the second extension sandwiched between the housing and a third side of the periphery that connects the two opposite sides of the periphery, and the third extension sandwiched between the other of the two opposite sides of the periphery and the housing to restrict bypassing of the second fluid around the open flow passages.

10. The heat exchanger of claim 9 wherein the seal structure is a multi-piece structure.

11. The heat exchanger of claim 9 wherein the seal structure is a one-piece seal structure.

12. The heat exchanger of claim 9 wherein the first and third extensions conform to the contoured shapes of the two opposite sides of the periphery.

13. The heat exchanger of claim 9 wherein the housing comprises a cast housing having a core chamber that receives the core and surrounds the core except for a fourth side of the periphery opposite from the third side, the core chamber having an inlet for the second fluid and a outlet for the second fluid with the core positioned in the core chamber between the inlet and the outlet for the second fluid.

14. The heat exchanger of claim 9 wherein the core further comprises a fluid connection extending from the third side of the periphery of the core to direct the first fluid to or from the core, the housing includes an opening sized to allow passage of the fluid connection, and the third extension includes a gasket section that engages around the fluid connection and the opening to restrict leakage of the second fluid from the housing.

15. The heat exchanger of claim 9 wherein the contoured shapes of the two opposite sides comprises a plurality of recesses and the first and third extensions each comprises a plurality of corresponding projections extending into the recesses of the corresponding opposite side.

16. The heat exchanger of claim 9 wherein the core comprises a plurality of plate pairs, each plate pair defining one of the enclosed flow passages, each of the open flow passage is defined between two adjacent plate pairs, and each of the first and third extensions comprises a plurality of projections, each of the projections extending between two adjacent plate pairs at the corresponding the opposite side.

17. A heat exchanger comprising:
a heat exchanger core having a pair of opposite faces bounded by a periphery, the core comprising a plurality of enclosed flow passages to direct a first fluid through the core and a plurality of open flow passages extending between the opposite face to direct a second fluid through the core;
a housing surrounding the core to define an inlet manifold area for the second fluid to direct the second fluid into the second flow passages at one of the faces and an outlet manifold for the second fluid to collect the second fluid from the second flow passages at the other face; and
a seal structure sandwiched between the housing and a majority of the periphery to restrict bypassing of the second fluid around the open flow passages.

18. The heat exchanger of claim 17 wherein the seal structure is a multi-piece structure.

19. The heat exchanger of claim 17 wherein the seal structure is a one-piece seal structure.

20. The heat exchanger of claim 17 wherein the seal conforms to contoured shapes of two opposite sides of the periphery.

21. The heat exchanger of claim 17 wherein the housing comprises a cast housing having a core chamber that receives the core with the core positioned in the core chamber between an inlet and outlet for the second fluid.

22. The heat exchanger of claim 21 wherein the core further comprises a fluid connection extending from the third side of the periphery of the core to direct the first fluid to or from the core, the chamber includes an opening sized to allow passage of the fluid connection, and the third extension includes a gasket section that engages around the fluid connection and the opening to restrict leakage of the second fluid from the housing.

23. The heat exchanger of claim 17 wherein two opposite sides of the periphery comprise a plurality of recesses and the seal comprises a plurality of corresponding projections extending into the recesses.

24. The heat exchanger of claim 17 wherein the core comprises a plurality of plate pairs, each plate pair defining one of the enclosed flow passages, each of the open flow passage is defined between two adjacent plate pairs, and the seal comprises a plurality of projections, each of the projections extending between two adjacent plate pairs at the periphery of the core.
